(19) United States
(12) Patent Application Publication
(10) Pub. No.: US 2012/0264371 A1
(43) Pub. Date: Oct. 18, 2012

(54) APPARATUS AND METHOD FOR CONTROLLING TIME SYNCHRONIZATION BETWEEN BASE STATIONS

(75) Inventor: Myung Soon KIM, Daejeon (KR)

(73) Assignee: Electronics and Telecommunications Research Institute, Daejeon (KR)

(21) Appl. No.: 13/414,059

(22) Filed: Mar. 7, 2012

(30) Foreign Application Priority Data
Apr. 18, 2011 (KR) 10-2011-0035740
Jun. 30, 2011 (KR) 10-2011-0064488

(51) Int. Cl. H04W 56/00; H04B 7/19

(52) U.S. Cl. 455/13.2

(57) ABSTRACT

Provided are an apparatus and a method for controlling time synchronization between base stations when a receiving state of a satellite signal is poor. The present invention provide an apparatus and a method for controlling time synchronization between base stations that controls time synchronization between base stations based on reliability about time synchronization information of each base station.

### CROSS-REFERENCE TO RELATED APPLICATIONS

This application claims priority to and the benefit of Korean Patent Application Nos. 10-2011-0035740 and 10-2011-0064488 filed in the Korean Intellectual Property Office on Apr. 18, 2011 and Jun. 30, 2011, the entire contents of which are incorporated herein by reference.

### TECHNICAL FIELD

The present invention relates to an apparatus and a method for controlling time synchronization between base stations when a receiving state of a satellite signal is poor, and more particularly, to a system performing time synchronization between base stations using the apparatus.

### BACKGROUND ART

Currently, a system performing time synchronization between base stations obtains time synchronization of the entire system using a global navigation satellite system (GLASS), particularly, a global positioning system (GPS), and provides a call service based on the obtained time synchronization. Therefore, maintaining time synchronization of the entire system may be a very important element that is directly connected to maintaining of a call service. FIG. 1 is a configuration diagram of a mobile communication network adopting a synchronization scheme according to the related art.

In FIG. 1, a signal link between a mobile communication terminal 110 and a base station (BS) 120 requires time synchronization between systems. To guarantee mobility of the mobile communication terminal 110, synchronization is required even in a part that includes the base station 120 and a radio network control station (RNC) 130. All of the base stations receive a time synchronization signal from a GNSS satellite and determine an occurrence point in time of a transmission signal based on the received time synchronization signal. That is, the current system receives a time synchronization signal from the GNSS satellite to perform time synchronization between base stations. Here, when a receiving state of a satellite signal becomes poor/impossible, a system may not be normally driven. Accordingly, there is a need for a method that may cope with the above situation.

### SUMMARY OF THE INVENTION

The present invention has been made in an effort to provide an apparatus and a method for controlling time synchronization between base stations that controls time synchronization between base stations based on reliability about time synchronization information of each base station.

An exemplary embodiment of the present invention provides an apparatus for controlling time synchronization between base stations, the apparatus comprising: a time synchronization information collecting unit to collect, from each base station, time synchronization information for the time synchronization between the base stations; a reliability determining unit to determine whether at least one reliability value among reliability values about a current time obtained from each time synchronization information is greater than a threshold; and a time synchronization control unit to control the time synchronization between the base stations based on first time synchronization information associated with a reliability value greater than the threshold when at least one reliability value is greater than the threshold, and to control the time synchronization between the base stations based on predetermined second time synchronization information when all of the reliability values are less than the threshold.

The time synchronization controlling apparatus may further include: a reliability determination control unit to control whether a reliability value obtained from a satellite signal for each base station is greater than the threshold to be determined; and a current time information obtaining unit to obtain current time information from a first base station when there is the first base station of which the reliability value obtained from the satellite signal is greater than the threshold. The time synchronization control unit may control the synchronization based on the obtained current time information.

The time synchronization controlling apparatus may further include: a time synchronization information calculating unit to calculate third time synchronization information using a provided local oscillator for every predetermined time; and a database constructing unit to construct a database to enable the first time synchronization information or the third time synchronization information to be available as the second time synchronization information for use of a backup.

The time synchronization controlling apparatus may further include: a base station state determining unit to primarily determine whether each base station receives a satellite signal for obtaining the time synchronization information, or to secondarily determine whether each base station is capable of calculating the reliability value, in interaction with the base stations; and a drive control unit to control the time synchronization information collecting unit, the reliability determining unit, and the time synchronization control unit to be driven when at least one base station does not receive the satellite signal for obtaining the time synchronization information as a result of the primary determination, or when at least one base station does not calculate the reliability value as a result of the secondary determination. The base station state determining unit may perform the primary determination or the secondary determination for every predetermined time.

The time synchronization controlling apparatus may further include a reliability calculating unit to determine the reliability value for each base station using parameters that are obtained when processing a satellite signal for obtaining the time synchronization information. The parameters may include a signal to noise ratio (SNR) of the received satellite signal, a positioning error value by the received satellite signal, and pseudo distance information obtained from the received satellite signal, as elements. The reliability calculating unit may determine the reliability value using at least one element.

Another exemplary embodiment of the present invention provides a method of controlling time synchronization between base stations, the method comprising: a time synchronization information collecting step of collecting, from each base station, time synchronization information for the time synchronization between the base stations; a reliability determining step of determining whether at least one reliability value among reliability values about a current time obtained from each time synchronization information is greater than a threshold; and a time synchronization control step of controlling the time synchronization between the base stations based on first time synchronization information associated with a reliability value greater than the threshold when at least one reliability value is greater than the threshold, and controlling the time synchronization between the base stations based on predetermined second time synchronization information when all of the reliability values are less than the threshold.

The time synchronization controlling method may further include: a reliability determination control step of controlling whether a reliability value obtained from a satellite signal for each base station is greater than the threshold to be determined; and a current time information obtaining step of obtaining current time information from a first base station when there is the first base station of which the reliability value obtained from the satellite signal is greater than the threshold. The time synchronization control step may control the synchronization based on the obtained current time information.

The time synchronization controlling method may further include: a time synchronization information calculating step of calculating third time synchronization information using a provided local oscillator for every predetermined time; and a database constructing step of constructing a database to enable the first time synchronization information or the third time synchronization information to be available as the second time synchronization information for use of a backup.

The time synchronization controlling method may further include: a base station state determining step of primarily determining whether each base station receives a satellite signal for obtaining the time synchronization information, or secondarily determining whether each base station is capable of calculating the reliability value, in interaction with the base stations; and a drive control step of controlling the time synchronization information collecting step, the reliability determining step, and the time synchronization control step to be sequentially performed when at least one base station does not receive the satellite signal for obtaining the time synchronization information as a result of the primary determination, or when at least one base station does not calculate the reliability value as a result of the secondary determination. The base station state determining step may perform the primary determination or the secondary determination for every predetermined time.

The time synchronization controlling method may further include a reliability deciding step of determining the reliability value for each base station using parameters that are obtained when processing a satellite signal for obtaining the time synchronization information. The parameters may include an SNR of the received satellite signal, a positioning error value by the received satellite signal, and pseudo distance information obtained from the received satellite signal, as elements. The reliability deciding step may determine the reliability value using at least one element.

According to exemplary embodiments of the present invention, constituent elements within a mobile communication network in a wireless environment where a signal is not smoothly received from a global navigation satellite system (GNSS) may not be influenced by the corresponding wireless environment and may share and use robust time synchronization information by controlling time synchronization between base stations based on reliability about time synchronization information of each base station. Also, it is possible to prevent degradation in the call quality of a system according to time synchronization mismatching, and to prevent shift to a state in which handover is impossible.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a configuration diagram of a mobile communication network adopting a synchronization method according to the related art.

FIG. 2 is a block diagram schematically illustrating an apparatus for controlling time synchronization between base stations according to an exemplary embodiment of the present invention.

FIGS. 3A, 3B, 3C and 3D are block diagrams schematically illustrating a configuration addable to an apparatus for controlling time synchronization between base stations according to the present exemplary embodiment.

FIG. 4 is a flowchart illustrating an operation method of a communication system according to the present exemplary embodiment.

FIG. 5 is a flowchart schematically illustrating a method of controlling time synchronization according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. First of all, we should note that in giving reference numerals to elements of each drawing, like reference numerals refer to like elements even though like elements are shown in different drawings. In describing the present invention, well-known functions or constructions will not be described in detail since they may unnecessarily obscure the understanding of the present invention. It should be understood that although exemplary embodiment of the present invention are described hereafter, the spirit of the present invention is not limited thereto and may be changed and modified in various ways by those skilled in the art.

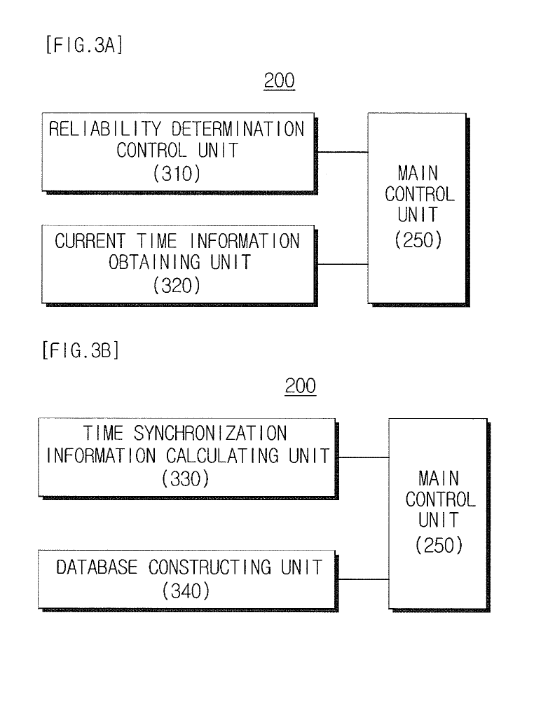

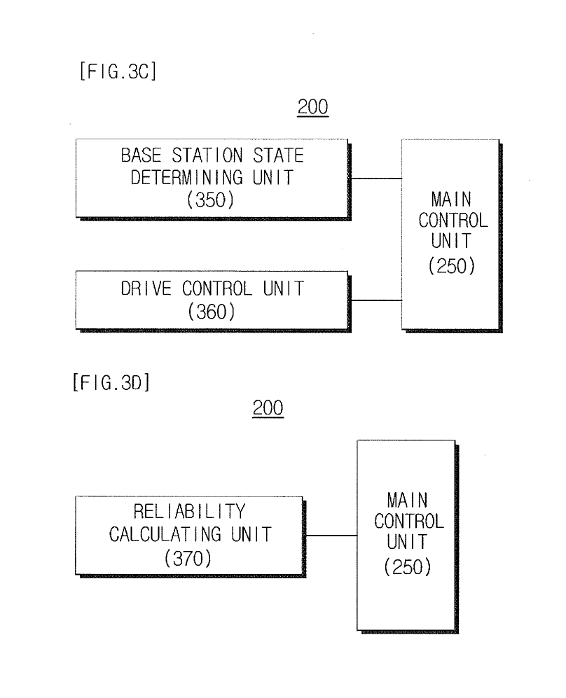

FIG. 2 is a block diagram schematically illustrating an apparatus for controlling time synchronization between base stations according to an exemplary embodiment of the present invention. FIGS. 3A, 3B, 3C and 3D is a block diagram schematically illustrating a configuration addable to an apparatus for controlling time synchronization between base stations according to the present exemplary embodiment. Hereinafter, the apparatus for controlling time synchronization between base stations will be described with reference to FIGS. 2 and 3. The apparatus 200 for controlling time synchronization between base stations is referred to as the time synchronization controlling apparatus 200.

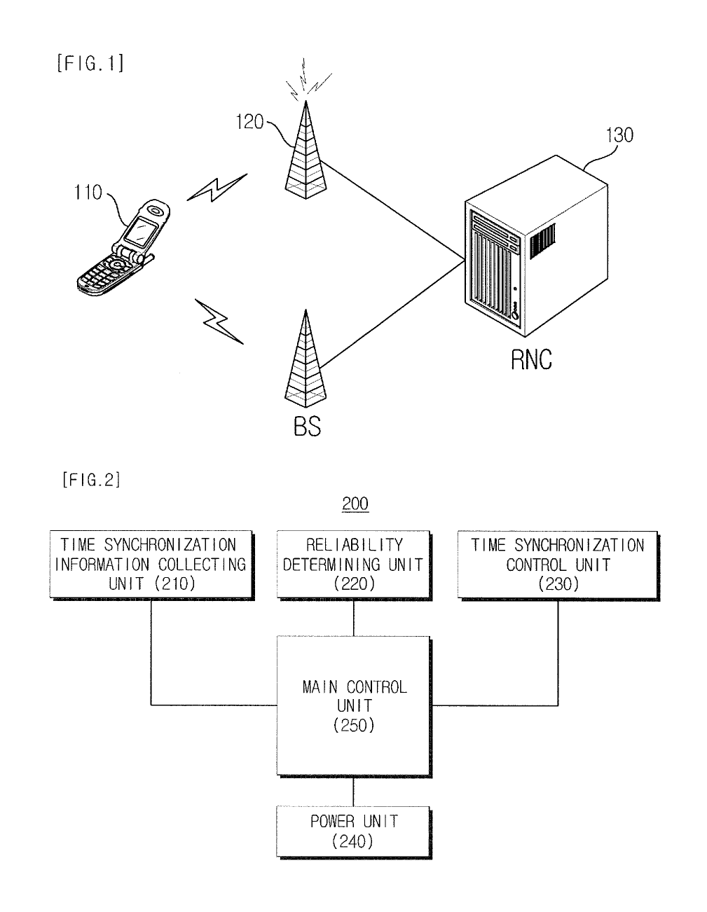

Referring to FIG. 2, the time synchronization controlling apparatus 200 includes a time synchronization information collecting unit 210, a reliability determining unit 220, a time synchronization control unit 230, a power unit 240, and a main control unit 250. As shown in FIG. 1, a communication system includes at least one radio network control station (RNC), and each RNC is connected to at least one base station. The time synchronization controlling apparatus 200 according to the present exemplary embodiment is provided to the RNC.

The time synchronization information collecting unit 210 functions to collect, from each base station, time synchronization information for the time synchronization between base stations. The reliability determining unit 220 functions to determine whether at least one reliability value among reliability values about a current time obtained from each time synchronization information is greater than a threshold. The time synchronization control unit 230 functions to control the time synchronization between the base stations based on first time synchronization information associated with a reliability value greater than the threshold when at least one reliability value is greater than the threshold, and to control the time synchronization between the base stations based on predetermined second time synchronization information when all of the reliability values are less than the threshold.

In the communication system applied with the present exemplary embodiment, each base station may perform reliability determination. Considering the above aspect, the time synchronization controlling apparatus 200 may further include a reliability determination control unit 310 and a current time information obtaining unit 320, as shown in FIG. 3A. The reliability determination control unit 310 functions to control whether a reliability value obtained from a satellite signal for each base station is greater than the threshold to be determined. The current time information obtaining unit 320 functions to obtain current time information from a first base station when there is the first base station of which the reliability value obtained from the satellite signal is greater than the threshold. When the time synchronization controlling apparatus 200 includes the above configuration, the time synchronization control unit 230 controls the time synchronization between base stations based on the obtained current time information.

In the communication system applied with the present exemplary embodiment, it is possible to improve the accuracy of time synchronization by performing time synchronization between base stations using time synchronization information in which the reliability value is greater than the threshold. Considering the above aspect, the time synchronization controlling apparatus 200 may further include a time synchronization information calculating unit 330 and a database constructing unit 340, as shown in FIG. 3B. The time synchronization information calculating unit 330 functions to calculate third time synchronization information using a provided local oscillator for every predetermined time. The database constructing unit 340 functions to construct a database to enable the first time synchronization information or the third time synchronization information to be available as the second time synchronization information for use of a backup.

The communication system applied with the present exemplary embodiment may determine whether to drive the time synchronization controlling apparatus 200 by determining a state of the base station such as whether a satellite signal is normally received for every predetermined time, whether an apparatus for processing a received signal is normally driven, and the like. Considering the above aspect, the time synchronization controlling apparatus 200 may further include a base station state determining unit 350 and a drive control unit 360, as shown in FIG. 3C. The base station state determining unit 350 functions to primarily determine whether each base station receives a satellite signal for obtaining the time synchronization information, or to secondarily determine whether each base station is capable of calculating the reliability value, in interaction with the base stations. The base station state determining unit 350 may perform the primary determination or the secondary determination for every predetermined time. The drive control unit 360 functions to control the time synchronization information collecting unit 210, the reliability determining unit 220, and the time synchronization control unit 230 to be driven when at least one base station does not receive the satellite signal for obtaining the time synchronization information as a result of the primary determination, or when at least one base station does not calculate the reliability value as a result of the secondary determination. In the above, “for every predetermined time” indicates at predetermined time intervals, frequently, and the like.

Meanwhile, according to the present exemplary embodiment, the time synchronization controlling apparatus 200 may perform reliability evaluation with respect to each base station. Here, the time synchronization controlling apparatus 200 may further include a reliability calculating unit 370, as shown in FIG. 3D. The reliability calculating unit 370 functions to determine the reliability value for each base station using parameters that are obtained when processing a satellite signal for obtaining the time synchronization information. The reliability value is determined based on the parameters obtained during a process of processing a global positioning system (GPS)/GNSS signal for each base station. Therefore, the function may also be performed at each base station. The parameters may include a signal to noise ratio (SNR) of the received satellite signal, a positioning error value by the received satellite signal, and pseudo distance information obtained from the received satellite signal, as elements. Here, the reliability calculating unit 370 may determine the reliability value using at least one element.

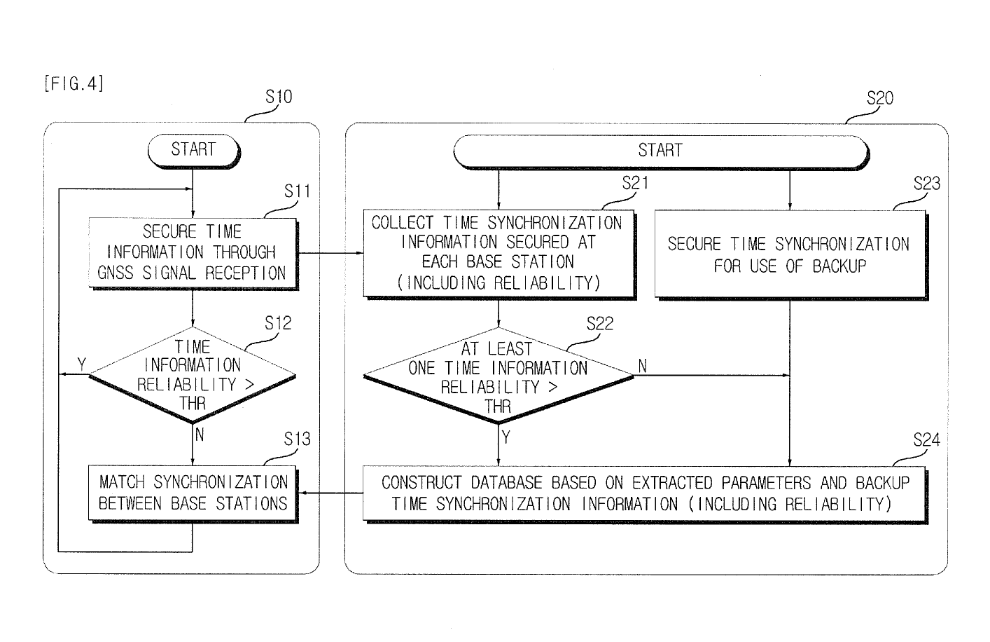

Next, the time synchronization controlling apparatus 200 of FIGS. 2, 3A, 3B, 3C and 3D and the communication system including the apparatus 200 will be described using an exemplary embodiment. FIG. 4 is a flowchart illustrating an operation method of a communication system according to the present exemplary embodiment. Hereinafter, the description will be made with reference to FIG. 4.

In the related art, when time information using a GNSS is not secured, a plurality of phenomena such as loss of a call, handover impossibility, and the like have occurred due to mismatching of time synchronization information between base stations (BSs) within an RNC. The present exemplary embodiment is proposed to solve the above problems and thus, operates in a form of ADD-ON with respect to an existing base station operation that secures time information by receiving a GNSS signal. When the present exemplary embodiment is applied, it is possible to be unaffected by a wireless environment and to secure robustness of time synchronization instead of employing a scheme of securing time synchronization between mobile communication networks by receiving a GNSS signal using a highly reliable time synchronization controlling apparatus. The detailed operation flowchart is shown in FIG. 4. In FIG. 4, S10 indicates a flowchart associated with securing time synchronization between base stations and S20 indicates a flowchart associated with securing time synchronization between RNCs.

When a relevant operation starts, time information based on an atomic clock is extracted through GNSS signal reception processing (S11). Reliability of the extracted time information is determined based on a plurality of parameters occurring during a received signal processing process. When the reliability exceeds a predetermined threshold (S12), an operation of securing time information through continuous GNSS signal reception is performed. On the other hand, when the time information reliability does not exceed the threshold (S12), synchronization between base stations is matched based on time synchronization information calculated based on information that is transmitted from an RNC to a corresponding base station (S13). Here, parameters used to determine the reliability may include, for example, an SNR of a GNSS received signal, a positioning error value, a pseudo distance change rate, and the like.

Parameters that may be used to determine the reliability may include an SNR or CNo, the positioning error rate, the pseudo distance change rate, and the like. Even though a method of determining the reliability based on the above parameters may be different depending on embodiments, an exemplary embodiment is as follows. When CNo with respect to each channel is used as a parameter to determine the reliability, and when there are four or less channels in which CNo does not exceed a predetermined value, an operation may be performed such that the calculated reliability of time synchronization information is set to be less than an arbitrarily determined reliability threshold. As another example, when the reliability is determined based on CNo and the positioning error value, CNo may be operated as described above. While operating CNo as above, when the positioning error value exceeds an arbitrarily determined positioning error value, an operation may be performed such that the calculated reliability of time synchronization information is set to be less than the arbitrarily determined reliability threshold. A method of determining the reliability through a plurality of combinations may be embodied.

The time synchronization indicates that all of the base stations (BSs) within the RNC use the same information as the time information. A resolution of time synchronization information required for a voice call and the like is not very high. However, a resolution of time synchronization information required for financial transaction and the like using the mobile communication network is very high. To use the same information in all of the base stations within the RNC while satisfying the resolution, time information is extracted based on information coming from a GPS satellite and thereby used.

The time information extracted from the base station in S11 is transmitted to the RNC. The corresponding station collects time synchronization information calculated at each base station, including the reliability (S21). A parameter to be transmitted to each base station is extracted based on the collected information. Here, the extracted parameter is time information and may be configured such that a user collects and distributes required information for expansibility under a mutual promise. Also, a database is configured based on the extracted parameter and is configured, including the reliability. The corresponding database is provided in a form that may be referred to by each base station. For an operation of handover between base stations, information in a form of PN_OFFSET and PN_PHASE may be provided from the RNC to each base station. However, under the assumption that an absolute time is known, only a corresponding parameter is provided. Therefore, when a GNSS signal is not smoothly received, and when the reliability of extracted time information is low based on the reliability of extracted time information, the base station may operate to receive a central control. The base station repeatedly performs a loop of securing time synchronization. A GNSS signal receiving state may vary and thus, the base station may secure time synchronization information through continuous GNSS signal reception and selectively operate based on the reliability. At the same time, when a GNSS signal is not smoothly received at each base station, the RNC databases available time synchronization information based on time synchronization information calculated at each base station (S24). Here, the RNC databases the time synchronization information using collection values in which the reliability of time information exceeds a predetermined threshold among the collected information (S22). When reliability values of time information calculated at all of the base stations within the RNC do not exceed the predetermined threshold, the RNC databases the time synchronization information based on the time synchronization that is secured in advance for use of a backup (S23). The time synchronization information that may be used for the backup may include information using a local oscillator of the RNC, information using a local oscillator of the base station, and the like. In addition, a plurality of time synchronization information may be used for the backup. The time synchronization information that may be used for the backup indicates time information having a low resolution. Here, the resolution is calculated in a network of an upper layer than the RNC, in a local oscillator of the RNC itself, and the like, in the structure of the mobile communication network. The time synchronization information that may be used for the backup is continuously secured once an operation of the RNC starts.

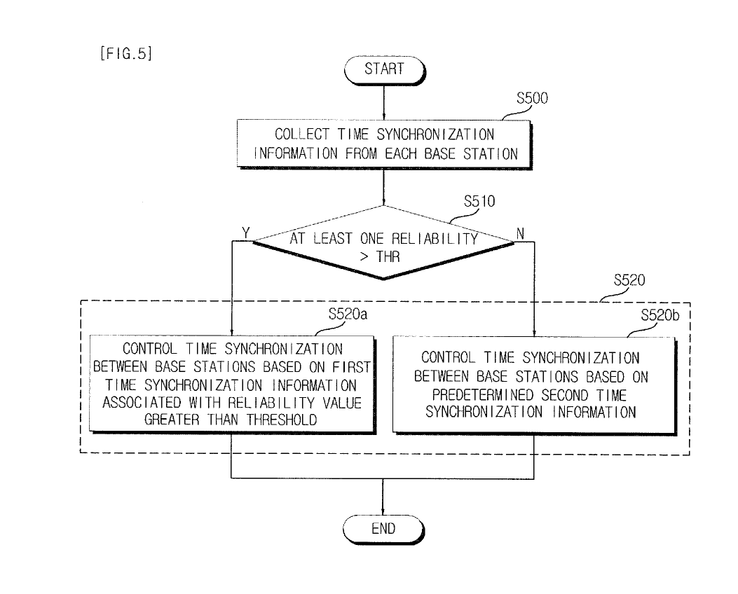

Next, a time synchronization controlling method of the time synchronization controlling apparatus 200 according to the present exemplary embodiment will be described. FIG. 5 is a flowchart schematically illustrating a method of controlling time synchronization according to an exemplary embodiment of the present invention. Hereinafter, the description will be made with reference to FIG. 5.

Initially, time synchronization information for time synchronization between base stations is collected from each base station (time synchronization information collecting step, S500). Next, whether at least one reliability value among reliability values about a current time obtained from each time synchronization information is greater than a threshold is determined (reliability determining step, S510). Next, when at least one reliability value is greater than the threshold, the time synchronization between the base stations is controlled based on first time synchronization information associated with a reliability value greater than the threshold (S520a). When all of the reliability values are less than the threshold, the time synchronization between the base stations is controlled based on predetermined second time synchronization information (S520b) (time synchronization control step, S520).

The present time synchronization controlling method may further perform a reliability determination control step and a current time information obtaining step. The reliability determination control step indicates a step of controlling whether a reliability value obtained from a satellite signal for each base station is greater than the threshold to be determined. The current time information obtaining step indicates a step of obtaining current time information from a first base station when there is the first base station of which the reliability value obtained from the satellite signal is greater than the threshold. When the present time synchronization controlling method performs the reliability determination control step and the current time information obtaining step, the time synchronization control step S520 controls time synchronization between base stations based on the obtained current time information. According to the present exemplary embodiment, the current time information obtaining step and the time synchronization information collecting step may be performed simultaneously. Considering the above aspect, the reliability determination control step may precede the time synchronization information collecting step.

The present time synchronization controlling method may further perform a time synchronization information calculating step and a database constructing step. The time synchronization information calculating step indicates a step of calculating third time synchronization information using a provided local oscillator for every predetermined time. The database constructing step indicates a step of constructing a database to enable the first time synchronization information or the third time synchronization information to be available as the second time synchronization information for use of a backup. The time synchronization information calculating step and the database constructing step are performed prior to the time synchronization control step S520. Considering the above aspect, the time synchronization information calculating step and the database constructing step may be performed prior to the time synchronization information collecting step S500, between the time synchronization information collecting step S500 and the reliability determining step S510, between the reliability determining step S510 and the time synchronization control step S520, and the like.

The present time synchronization controlling method may further perform a base station state determining step and a drive control step. The base station state determining step indicates a step of primarily determining whether each base station receives a satellite signal for obtaining the time synchronization information, or secondarily determining whether each base station is capable of calculating the reliability value, in interaction with the base stations. The base station state determining step may perform the primary determination or the secondary determination for every predetermined time. The drive control step indicates a step of controlling the time synchronization information collecting step S500, the reliability determining step S510, and the time synchronization control step S520 to be sequentially performed when at least one base station does not receive the satellite signal for obtaining the time synchronization information as a result of the primary determination, or when at least one base station does not calculate the reliability value as a result of the secondary determination. The base station state determining step and the drive control step are performed prior to the time synchronization information collecting step S500.

The present time synchronization controlling method may further perform a reliability deciding step. The reliability deciding step indicates a step of determining the reliability value for each base station using parameters that are obtained when performing a satellite signal for obtaining the time synchronization information. The reliability deciding step may be performed between the time synchronization information collecting step S500 and the reliability determining step S510. This considers a case where the RNC performs the reliability value determination. When each base station determines a reliability value, the reliability deciding step is performed prior to the time synchronization information collecting step. This is because the reliability value determined at each base station is included in the time synchronization information and thereby is collected. In the above, the parameters may include an SNR of the received satellite signal, a positioning error value by the received satellite signal, and pseudo distance information obtained from the received satellite signal, as elements. Here, the reliability deciding step may determine the reliability value using at least one element.

The present invention may provide time synchronization having high reliability between base stations by controlling time synchronization between base stations based on reliability about time synchronization information of each base station. Also, the present invention may enable each base station to use generated time reference information based on a result of collecting time reference information generated at the base station and backup information. Therefore, time synchronization information not influenced by the environment may be secured through information exchange between the base station and a radio network control station. Even in various environments or a poor environment, robust time reference information may be provided.

The present invention may be applied to a mobile communication network requiring time synchronization between base stations. Also, the present invention may be applied to a multi-navigation frequency monitoring and using field.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. An apparatus for controlling time synchronization between base stations, the apparatus comprising:
a time synchronization information collecting unit to collect, from each base station, time synchronization information for the time synchronization between the base stations;
a reliability determining unit to determine whether at least one reliability value among reliability values about a current time obtained from each time synchronization information is greater than a threshold; and
a time synchronization control unit to control the time synchronization between the base stations based on first time synchronization information associated with a reliability value greater than the threshold when at least one reliability value is greater than the threshold, and to control the time synchronization between the base stations based on predetermined second time synchronization information when all of the reliability values are less than the threshold.

2. The apparatus of claim 1, further comprising:
a reliability determination control unit to control whether a reliability value obtained from a satellite signal for each base station is greater than the threshold to be determined; and
a current time information obtaining unit to obtain current time information from a first base station when there is the first base station of which the reliability value obtained from the satellite signal is greater than the threshold,
wherein the time synchronization control unit controls the synchronization based on the obtained current time information.

3. The apparatus of claim 1, further comprising:
a time synchronization information calculating unit to calculate third time synchronization information using a provided local oscillator for every predetermined time; and
a database constructing unit to construct a database to enable the first time synchronization information or the third time synchronization information to be available as the second time synchronization information for use of a backup.

4. The apparatus of claim 1, further comprising:
a base station state determining unit to primarily determine whether each base station receives a satellite signal for obtaining the time synchronization information, or to secondarily determine whether each base station is capable of calculating the reliability value, in interaction with the base stations; and
a drive control unit to control the time synchronization information collecting unit, the reliability determining unit, and the time synchronization control unit to be driven when at least one base station does not receive the satellite signal for obtaining the time synchronization information as a result of the primary determination, or when at least one base station does not calculate the reliability value as a result of the secondary determination.

5. The apparatus of claim 4, wherein the base station state determining unit performs the primary determination or the secondary determination for every predetermined time.

6. The apparatus of claim 1, further comprising:
a reliability calculating unit to determine the reliability value for each base station using parameters that are obtained when processing a satellite signal for obtaining the time synchronization information.

7. The apparatus of claim 6, wherein:
the parameters include a signal to noise ratio (SNR) of the received satellite signal, a positioning error value by the received satellite signal, and pseudo distance information obtained from the received satellite signal, as elements, and
the reliability calculating unit determines the reliability value using at least one element.

8. A method of controlling time synchronization between base stations, the method comprising:
a time synchronization information collecting step of collecting, from each base station, time synchronization information for the time synchronization between the base stations;
a reliability determining step of determining whether at least one reliability value among reliability values about a current time obtained from each time synchronization information is greater than a threshold; and
a time synchronization control step of controlling the time synchronization between the base stations based on first time synchronization information associated with a reliability value greater than the threshold when at least one reliability value is greater than the threshold, and controlling the time synchronization between the base stations based on predetermined second time synchronization information when all of the reliability values are less than the threshold.

9. The method of claim 8, further comprising:
a reliability determination control step of controlling whether a reliability value obtained from a satellite signal for each base station is greater than the threshold to be determined; and
a current time information obtaining step of obtaining current time information from a first base station when there is the first base station of which the reliability value obtained from the satellite signal is greater than the threshold,
wherein the time synchronization control step controls the synchronization based on the obtained current time information.

10. The method of claim 8, further comprising:
a time synchronization information calculating step of calculating third time synchronization information using a provided local oscillator for every predetermined time; and
a database constructing step of constructing a database to enable the first time synchronization information or the third time synchronization information to be available as the second time synchronization information for use of a backup.

11. The method of claim 8, further comprising:
a base station state determining step of primarily determining whether each base station receives a satellite signal for obtaining the time synchronization information, or secondarily determining whether each base station is capable of calculating the reliability value, in interaction with the base stations; and
a drive control step of controlling the time synchronization information collecting step, the reliability determining step, and the time synchronization control step to be sequentially performed when at least one base station does not receive the satellite signal for obtaining the time synchronization information as a result of the primary determination, or when at least one base station does not calculate the reliability value as a result of the secondary determination.

12. The method of claim 11, wherein the base station state determining step performs the primary determination or the secondary determination for every predetermined time.

13. The method of claim 8, further comprising:
a reliability deciding step of determining the reliability value for each base station using parameters that are obtained when processing a satellite signal for obtaining the time synchronization information.

14. The method of claim 13, wherein:
the parameters include an SNR of the received satellite signal, a positioning error value by the received satellite signal, and pseudo distance information obtained from the received satellite signal, as elements, and
the reliability deciding step determines the reliability value using at least one element.
